(19) United States
(12) Patent Application Publication
(10) Pub. No.: US 2007/0109544 A1
(43) Pub. Date: May 17, 2007

(54) Surface Plasmon Resonance Sensing System

(76) Inventors: Lai-Kwan Chau, Chiayi City (TW); Wen-Hsin Hsieh, Taipei City (TW); Wei-Ting Hsu, Jhonghe City (TW); Po-Liang Chen, Wugu Township (TW)

Correspondence Address: LAW OFFICES OF LAI & ASSOCIATES, P.C., STE 200, 5800 RANCHESTER, HOUSTON, TX, 77036, US

(21) Appl. No.: 11/558,850

(22) Filed: Nov. 10, 2006

(30) Foreign Application Priority Data
Nov. 11, 2005 (TW) 094139668

(51) Int. Cl. G01N 21/55

(52) U.S. Cl. 356/445

(57) ABSTRACT

A surface plasmon resonance sensing system comprised of an incidence illuminant, a modified optical fiber, a layer of gold nanoparticles, a micro-fluidic module, and an illuminant detector; the modified optical fiber related to an optical fiber stripped off a portion of its protection layer and a cladding layer; the layer of noble metal nanoparticles covering over the modified optical fiber; the micro-fluidic module related to a micro-fluidic chip for containing the modified optical fiber and a sample; and the illuminant detector operating to detect the light emitted from the modified optical fiber.

### BACKGROUND OF THE INVENTION

(a) Field of the Invention

The present invention is related to a surface plasmon resonance (SPR) sensing system, and more particularly to an SPR sensing system, apparatus, and method excited by noble metal nanoparticles.

(b) Description of the Prior Art

Surface plasmon resonance phenomenon is that when a light source illuminates a metal surface at a fixed incident angle, the reflection intensity detected by a light detector would be near zero, which means the reflectivity of the metal film is near zero. The light which is not reflected will propagate along interface direction at a certain velocity to resonantly excite the surface plasmon of the metal. The method of measuring the reflected light is known as Attenuated Total Reflection (ATR).

A surface plasmon resonance sensing system uses a sensing system made by surface plasmon resonance phenomenon. Because the surface plasmon resonance sensor has high sensitivity, is label-free for detecting molecules, and can analyze the interaction between molecules at real-time. Other advantages include short analysis time and capability of simultaneous parallel detection. The system is therefore in widespread use on detecting biomolecules.

Recently, the development of nanomaterials is applied to optoelectronics, communication and medical equipment. Nanomaterials may provide specific characteristics which completely differ from traditional materials. The prior art works on localized surface plasmon resonance (LSPR) excited by noble metal nanoparticles to replace the conventional propagating surface plasmon resonance (PSPR) excited by gold film for additional advantages such as shorter electromagnetic field decay length, smaller pixel size, faster response time, and capability of simultaneous LSPR sensing and surface-enhanced Raman scattering. Furthermore, LSPR sensors can be constructed by simple and low-cost optical designs while PSPR sensors require bulky and expensive optical equipment. Today, the roadmap for the development of SPR sensor is heading for a miniaturized design. Should the SPR sensor be made in smaller size for easy portability and available in simpler design of detection method and operation performance, its applications could have been significantly extended.

### SUMMARY OF THE INVENTION

The primary purpose of the present invention is to provide a surface plasmon resonance sensing system, apparatus, and method to further promote sensitivity of the sensing system, and reduce reaction time and consumption of test solution.

To achieve the foregoing object, an optical fiber is adapted instead of the conventional prism in the design of the sensing system since the optical fiber provides characteristics of low loss, high frequency band, free of EMI (electromagnetic interference), light-weighted, and small volume for significantly reducing the size of the sensing system. Whereas a micro-fluidic chip is essentially comprised of micro-fluidic devices including micro-fluidic channel, micro-pump, micro-valve, actuator, and micro-sensor for providing functions of multi-tasking process, movement, reaction, detection, and sample collection of test solution. The micro-fluidic chip is integrated in the present invention to further promote the sensitivity of the sensing system and reduce reaction time and consumption of the test solution.

Accordingly, the present invention is related to a surface plasmon resonance sensing system including an incidence illuminant, an optical fiber device, a noble metal nano-particles layer, a micro-fluidic module, and an illuminant detector. Wherein, the optical fiber device is an optical fiber where a portion of a protection layer and a cladding layer are stripped off; the noble metal nano-particle layer covers over the surface of the optical fiber device; the micro-fluidic module relates to a micro-fluidic chip to accommodate the optical fiber device and the sample; and the illuminant detector is operated to detect the emitted emergent light from the optical fiber device.

Whereas the present invention is adapted with the optical fiber with noble metal nano-particles instead of the conventional prism, the size of the SPR sensing system is significantly reduced, sensitivity further promoted, reaction time shortened, and consumption of test solution reduced by taking advantage of the micro-fluidic chip.

### BRIEF DESCRIPTION OF THE DRAWINGS

FIG. 1 is a schematic view showing a construction of optical fiber;

FIG. 2 is a schematic view showing that an optical fiber device is covered up by noble metal nano-particles;

FIG. 3 is a schematic view showing that a micro-fluidic chip is applied in the optical fiber sensing system;

FIG. 4 is a block chart of a surface plasmon resonance sensing system of the present invention;

FIG. 5 is a schematic view showing a preferred embodiment of the present invention; and

FIG. 6 is a process flow chart of the surface plasmon resonance sensing method of the present invention.

### DETAILED DESCRIPTION OF THE PREFERRED EMBODIMENTS

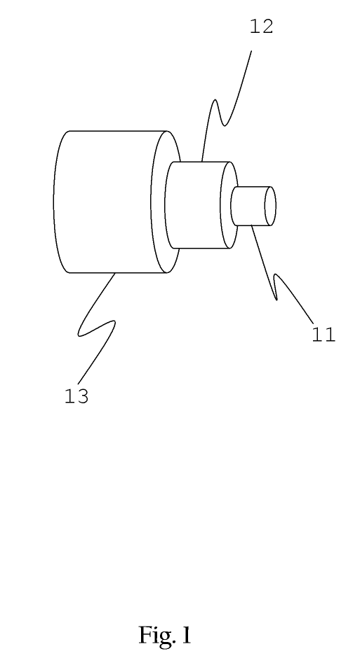

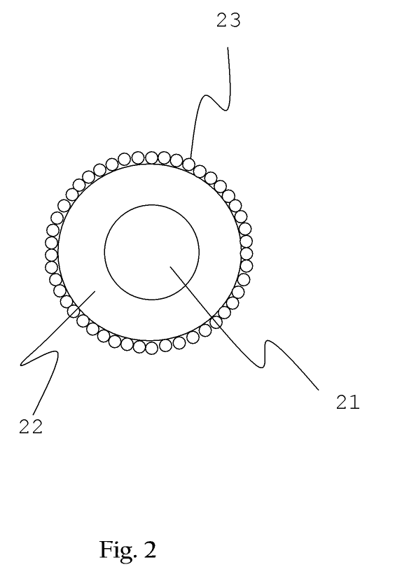

Referring to FIG. 1 for a schematic view showing construction of an optical fiber, the optical fiber is essentially comprised of three layers, respectively the innermost a core 11, a cladding 12 in the middle, an outermost protection 13 with materials and functions different from one another. As illustrated in FIG. 2 for a schematic view showing the optical fiber device covered with noble metal nano-particles, the optical fiber device is an optical fiber wherein a portion of a protection layer and a cladding layer are stripped off and preserved only a core layer 21 and, if exist, a residual cladding layer 22, and then a noble metal nano-particle layer 23 is covered up the surface of the optical fiber device. It should be noted that the cladding layer 22 could be totally stripped off to directly cover up the noble metal nano-particle layer.

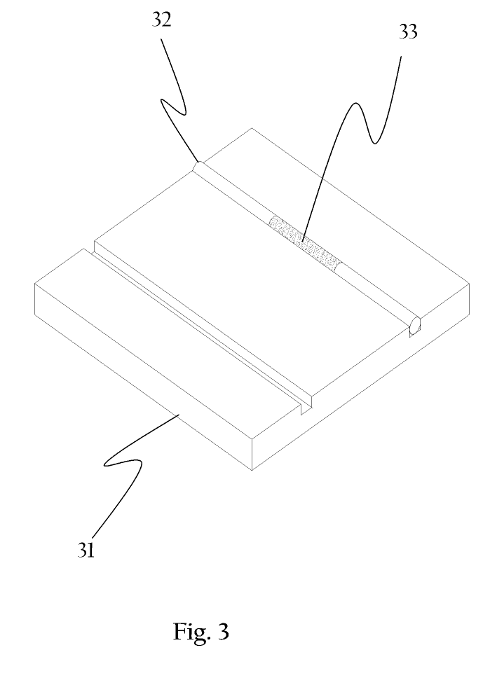

The present invention is related to a sensing system integrated with a micro-fluidic chip and the optical fiber clad by noble metal nano-particles. Wherein, the micro-fluidic chip is essentially comprised of micro-fluidic devices including micro-fluidic channel, micro-pump, micro-valve, actuator, and micro-sensor to provide functions of multi-tasking process, movement, reaction, detection, and sample collection of the test sample. With the integrated micro-fluidic chip, the present invention further promotes the sensitivity of the sensing system and shortens the reaction time. As illustrated in FIG. 3 showing that the micro-fluidic chip is applied in an optical fiber sensing system. A micro-fluidic chip 31 contains multiple micro-fluidic channels to accommodate the sample and an optical fiber device 32 and drives the sample to contact the noble metal nano-particles layer 33 on the surface of the optical fiber device 32.

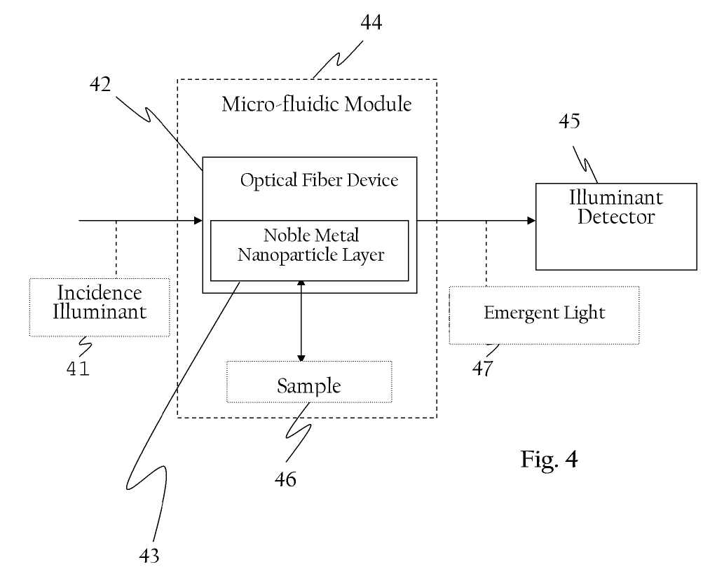

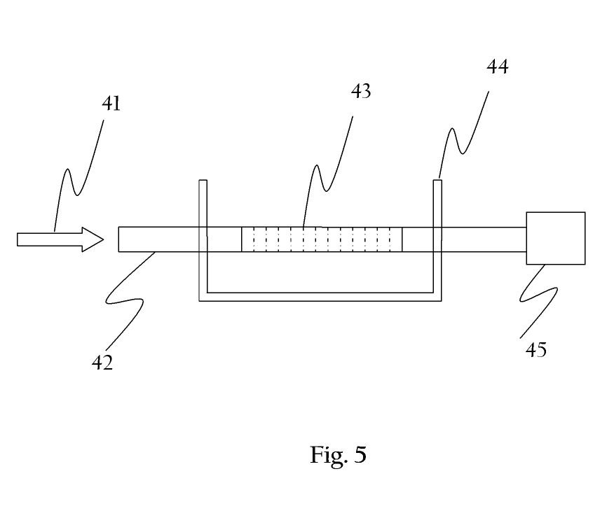

Now referring to FIGS. 4 and 5 respectively show a block chart and a preferred embodiment of the present invention. The system includes an incidence illuminant 41, an optical fiber device 42, a noble metal nano-particle layer 43, a micro-fluidic module 44, and an illuminant detector 45. Wherein, the incidence illuminant 41 relates to a single frequency light, a narrow band light or a white light; the optical fiber device 42 is related to an optical fiber where a portion of a protection layer and a cladding layer are stripped off; the noble metal nano-particle layer 43 is comprised of gold or silver nano-particles clad on the surface of the optical fiber device 42; the micro-fluidic module 44 is related to a micro-fluidic chip to accommodate the optical fiber device 42 and a sample 46 and drive the sample 46 to contact the noble metal nano-particle layer 43; the illuminant detector 45 is operated to detect an emergent light 47 from the optical fiber device 42; and the emergent light 47 may be related to a transmitted light, a reflected light, or leaked light from the region clad by noble metal nano-particles.

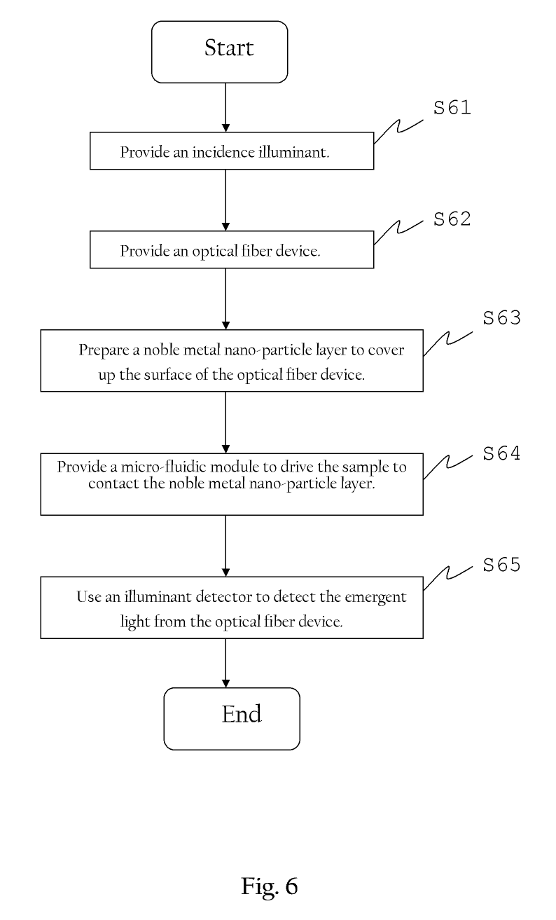

As illustrated in FIG. 6 for the process flow chart of the SPR sensing method of the present invention, the process includes the following steps:

S61: Provide an incidence illuminant;

S62: Provide an optical fiber device;

S63: Prepare a noble metal nano-particle layer to cover up the surface of the optical fiber device;

S64: Provide a micro-fluidic module to drive the sample to contact the noble metal nano-particle layer; and

S65: Use an illuminant detector to detect the emergent light from the optical fiber device.

The noble metal nano-particle layer is comprised of gold or silver nano-particles.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A surface plasmon resonance sensing system includes an incidence illuminant; an optical fiber device; a noble metal nano-particle layer covering up the surface of the optical fiber device; a micro-fluidic module to accommodate the optical fiber device and a sample and drive the sample to contact the noble metal nano-particle layer; and at least one light detector to detect an emergent light from the optical fiber device.

2. The surface plasmon resonance sensing system as claimed in claim 1, wherein the incidence illuminant relates to a single frequency light, a narrow band light or a white light.

3. The surface plasmon resonance sensing system as claimed in claim 1, wherein the optical fiber device is an optical fiber where a portion of a protection layer and a cladding layer are stripped off.

4. The surface plasmon resonance sensing system as claimed in claim 1, wherein the noble metal nano-particle layer is comprised of gold nano-particles.

5. The surface plasmon resonance sensing system as claimed in claim 1, wherein the noble metal nano-particle layer is comprised of silver nano-particles.

6. The surface plasmon resonance sensing system as claimed in claim 1, wherein the micro-fluidic module is related to a micro-fluidic chip.

7. The surface plasmon resonance sensing system as claimed in claim 1, wherein the emergent light from the optical fiber device relates to a transmitted light, reflected light, or leaked light from the region clad by noble metal nano-particles.

8. A surface plasmon resonance sensing method includes steps of:
providing an incidence illuminant; providing an optical fiber device;
preparing a noble metal nano-particle layer to cover up the surface of the optical fiber device;
providing a micro-fluidic module to accommodate the optical fiber device and a sample and to drive the sample to contact the noble metal nano-particle layer; and
using a light detector for detecting an emergent light from the optical fiber device.

9. The surface plasmon resonance sensing method as claimed in claim 8, wherein the method further provides a single frequency light, a narrow band light or a white light to function as the incidence illuminant.

10. The surface plasmon resonance sensing method as claimed in claim 8, wherein the method further includes an optical fiber wherein a portion of a protection layer and a cladding layer are stripped off to serve as the optical fiber device.

11. The surface plasmon resonance sensing method as claimed in claim 8, wherein the method further includes the noble metal nano-particle layer made of gold nano-particles.

12. The surface plasmon resonance sensing method as claimed in claim 8, wherein the method further includes the noble metal nano-particle layer made of silver nano-particles.

13. The surface plasmon resonance sensing method as claimed in claim 8, wherein the emergent light from the optical fiber device relates to a transmitted light, reflected light, or leaked light from the region clad by noble metal nano-particles.

14. The surface plasmon resonance sensing method as claimed in claim 8, wherein the method further includes a micro-fluidic chip to serve as the micro-fluidic module.

15. A surface plasmon resonance sensing apparatus includes an optical fiber device; a noble metal nano-particles layer covering up the surface of the optical fiber device; and a micro-fluidic module to accommodate the optical fiber device and a sample.

16. The surface plasmon resonance sensing apparatus as claimed in claim 15, wherein the optical fiber device is related to an optical fiber having been stripped off a portion of its protection layer and partially or totally stripped off its exposed cladding layer.

17. The surface plasmon resonance sensing apparatus as claimed in claim 15, wherein the noble metal nano-particle layer is comprised of gold nano-particles.

18. The surface plasmon resonance sensing apparatus as claimed in claim 15, wherein the noble metal nano-particle layer is comprised of silver nano-particles.

19. The surface plasmon resonance sensing apparatus as claimed in claim 15, wherein the micro-fluidic module is related to a micro-fluidic chip.
